(19) United States
(12) Patent Application Publication
(10) Pub. No.: US 2013/0006658 A1
(43) Pub. Date: Jan. 3, 2013

(54) SYSTEM AND METHOD FOR REMOTE MONITORING SERVICES

(75) Inventors: W. T. GREEN, III, Carrollton, GA (US); James T. Ingram, Carrollton, GA (US); Johnathan Samples, Carrollton, GA (US); Gregory H. Schulenburg, Carrollton, GA (US); Jason Colquitt, Carrollton, GA (US); Steve Felt, Hamilton, GA (US)

(73) Assignee: Greenway Medical Technologies, Inc., Carrollton, GA (US)

(21) Appl. No.: 13/539,756

(22) Filed: Jul. 2, 2012

Related U.S. Application Data
(60) Provisional application No. 61/503,856, filed on Jul. 1, 2011.

(51) Int. Cl. G06Q 50/22

(52) U.S. Cl. 705/2

(57) ABSTRACT

Users can use a portal for remote monitoring of clinical trials and the sites, personnel, and patients involved. A scheduling function allows users to schedule access. Site sponsors can run productivity reports.

### REFERENCE TO RELATED APPLICATION

The present application claims the benefit of U.S. Provisional Patent Application No. 61/503,856, filed Jul. 1, 2011, whose disclosure is hereby incorporated by reference in its entirety into the present disclosure.

### FIELD OF THE INVENTION

The present invention is directed to a computer-implemented system and method for remote monitoring of clinical trials and of the sites and personnel participating in those trials.

### DESCRIPTION OF RELATED ART

U.S. patent application Ser. No. 12/392,998, filed Feb. 25, 2009, titled SYSTEM AND METHOD FOR ANALYZING, COLLECTING AND TRACKING PATIENT DATA ACROSS A VAST PATIENT POPULATION, whose disclosure is hereby incorporated by reference in its entirety into the present disclosure, discloses a system and method of for analyzing, collecting, and tracking patient data across a vast patient population comprising a plurality of Electronic Health Record (EHR) systems provided at a plurality of healthcare provider sites, each EHR system comprising at least one means for capturing data for a plurality of patients in real time; comprising at least one research system for generating a dataset by performing at least one of analyzing, collecting, and tracking the data captured by the plurality of EHR systems in real time as the data is captured or from a database on which the captured data is stored; and comprising at least one workstation for setting the criteria by which the research system analyzes, collects and tracks the data captured by the plurality of EHR systems and for viewing the dataset generated by the at least one research system, wherein the dataset includes the data that corresponds to each of the criteria set at the workstation.

However, there is no provision for remote monitoring of clinical trials and the sites, personnel, and patients involved, as well as a scheduling function that allows users to schedule access and the ability of site sponsors to run productivity reports.

### SUMMARY OF THE INVENTION

It is therefore an object of the invention to provide such functionality.

To achieve the above and other objects, the present invention is directed to a computer-implemented method for remotely monitoring studies and the sites performing those studies, the method comprising: (a) receiving, into a computer, a scheduling request from a user to monitor the studies and the sites; (b) automatically remotely monitoring the studies and the sites from the computer in accordance with the scheduling request; and (c) allowing the user to search, using the computer, for information regarding the studies and the sites. The invention is further directed to a corresponding system and to a non-transient medium storing code for carrying out the invention.

The following is a disclosure of the invention in at least one embodiment. When screen shots of user interfaces are shown, it is considered that those skilled in the art who have reviewed the present disclosure will readily appreciate both the hardware and the coding to be used to implement such user interfaces. The present invention can be implemented on any computer-based medical records system, now or later to be developed, including without limitation stand-alone, LAN-based, and Internet-based medical records systems. The invention is usable with the invention disclosed in the above-cited '998 application.

### BRIEF DESCRIPTION OF THE DRAWINGS

A preferred embodiment will be set forth with reference to the drawings, in which:

FIG. 1 is a screen shot showing a login screen;

FIG. 2 is a screen shot showing the login screen in the event of a login failure;

FIG. 3 is a screen shot showing an email with a temporary user ID and password;

FIG. 4 is a screen shot showing a change of password;

FIG. 5 is a screen shot showing a screen for requesting a password reset;

FIG. 6 is a screen shot showing access scheduling;

FIG. 7 is a screen shot showing a message that there is no access request scheduled;

FIG. 8 is a screen shot showing the selection of a trial, site, or patient;

FIG. 9 is a screen shot showing a patient's medical record;

FIG. 10 is a screen shot showing a list of documents in a patient's medical chart;

FIG. 11 is a screen shot showing a document from the list of FIG. 10;

FIG. 12 is a screen shot showing the scheduling of access;

FIG. 13 is a screen shot showing the process of scheduling access;

FIG. 14 is a screen shot showing a message for confirmation of an access request;

FIG. 15 is a screen shot showing a view of all access requests for a week;

FIG. 16 is a screen shot showing a message to confirm cancellation of an access request;

FIG. 17 is a screen shot showing the status of an access request;

FIG. 18 is a screen shot showing a schedule log;

FIG. 19 is a screen shot showing selection of trials for which a monitor is appointed;

FIG. 20 is a screen shot showing an audit report;

FIG. 21 is a screen shot showing the selection of a trial that a CRO oversees;

FIG. 22 is a screen shot showing an audit report;

FIG. 23 is a screen shot showing entry of a date range for a financial report;

FIG. 24 is a screen shot showing a financial report;

FIG. 25 is a screen shot showing management of users; and

FIG. 26 is a schematic diagram showing hardware on which the preferred embodiment can be implemented,

### DETAILED DESCRIPTION OF THE PREFERRED EMBODIMENT

A preferred embodiment of the present invention will be set forth in detail with reference to the drawings, in which like reference numerals refer to like elements or steps throughout.

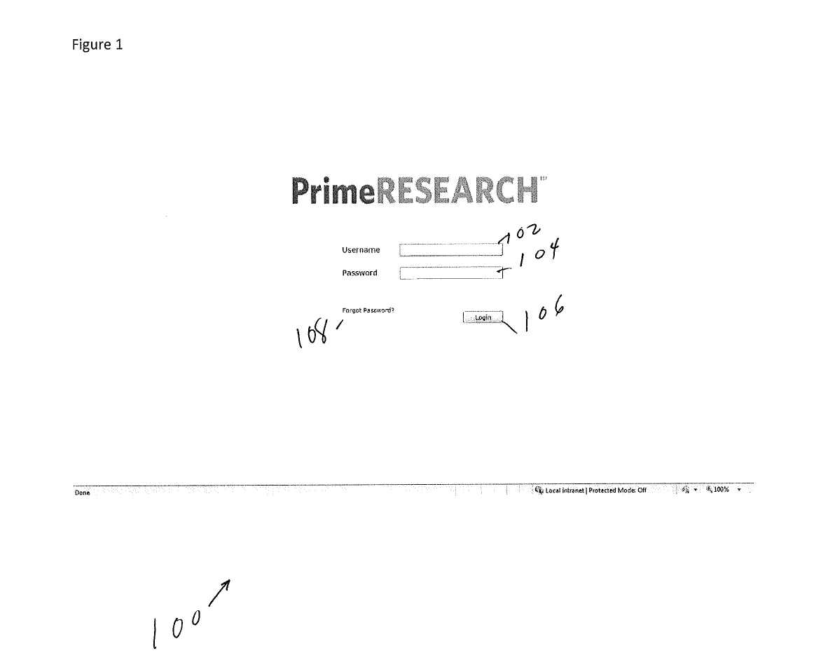

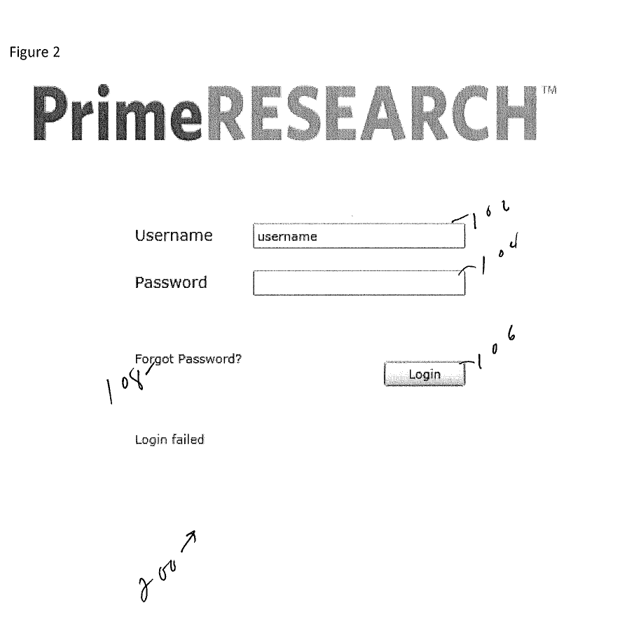

FIG. 1 shows a login screen 100. To login to the portal and gain access to the homepage for the specific user type, user must enter correct username/password combination into the boxes 102, 104 and click on ‘Login’ button 106. If the entered combination of username/password is not correct, the user will see a message “Login failed” on the login page screen, shown in FIG. 2 as 200. Also, users disabled by Admin will not be able to login to Research Portal and will get a system message “Login failed” when trying to login to the portal.

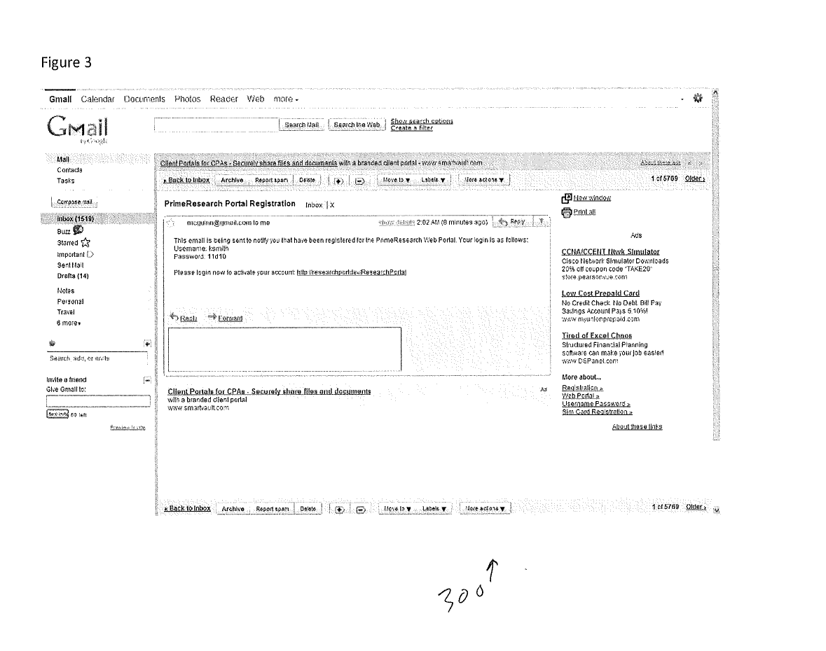

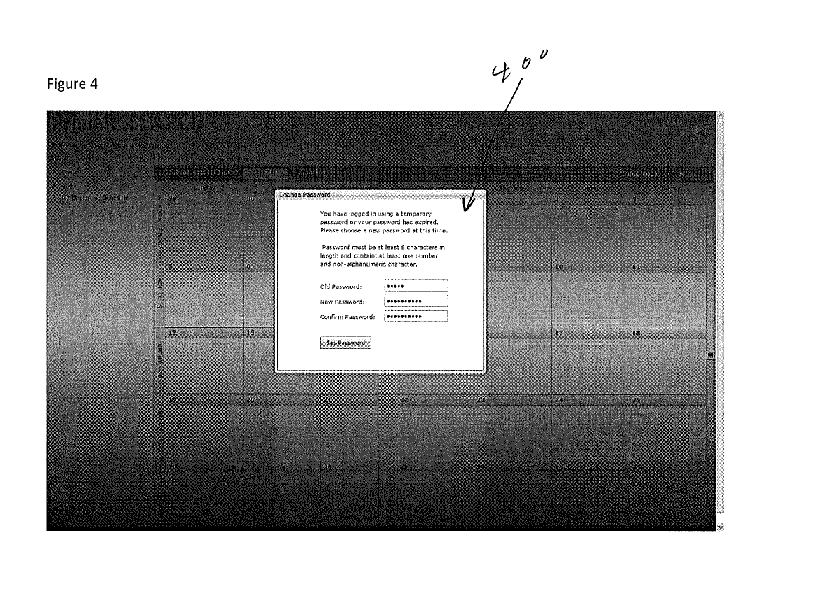

For first time users, a unique username and a temporary password will be assigned and sent via email, shown in FIG. 3 as 300, to the user to gain access to the login portal. The user will be prompted to reset their password through the dialog box 400 of FIG. 4 and may change it according to the specified requirements.

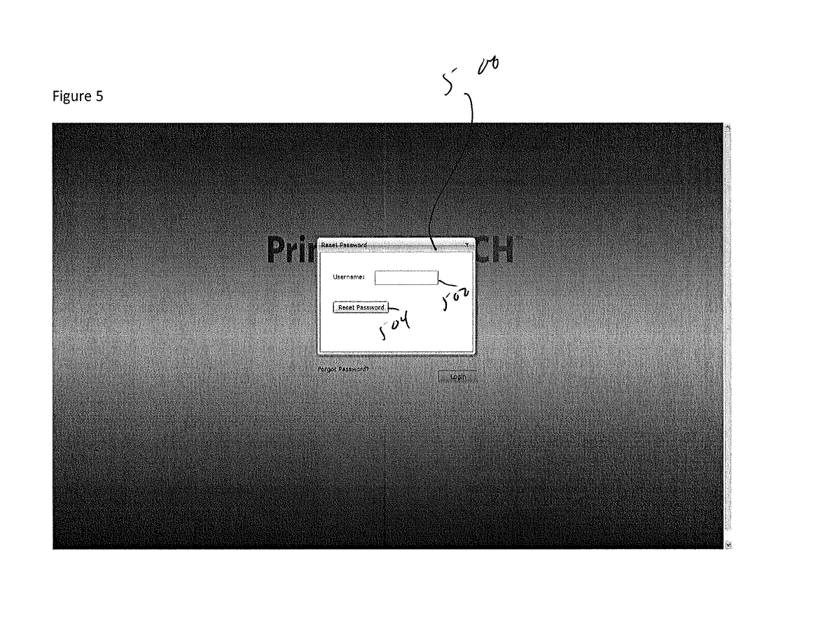

To regain a forgotten password, the user must click on ‘Forgot Password?’ link 108 of FIG. 2. The system will to generate a dialog box 500 of FIG. 5, allowing the user to input the username for which a new password should be created. After the user enters his/her username in the box 502 and clicks on the ‘Reset Password’ button 504, an email with a temporary password generated by the portal will be sent to the user's email address, as described above. The new password can be refused if it does not meet a complexity standard set by the system, the two entries of the new password do not match, or the user has not entered the correct old password.

The monitor view will now be described.

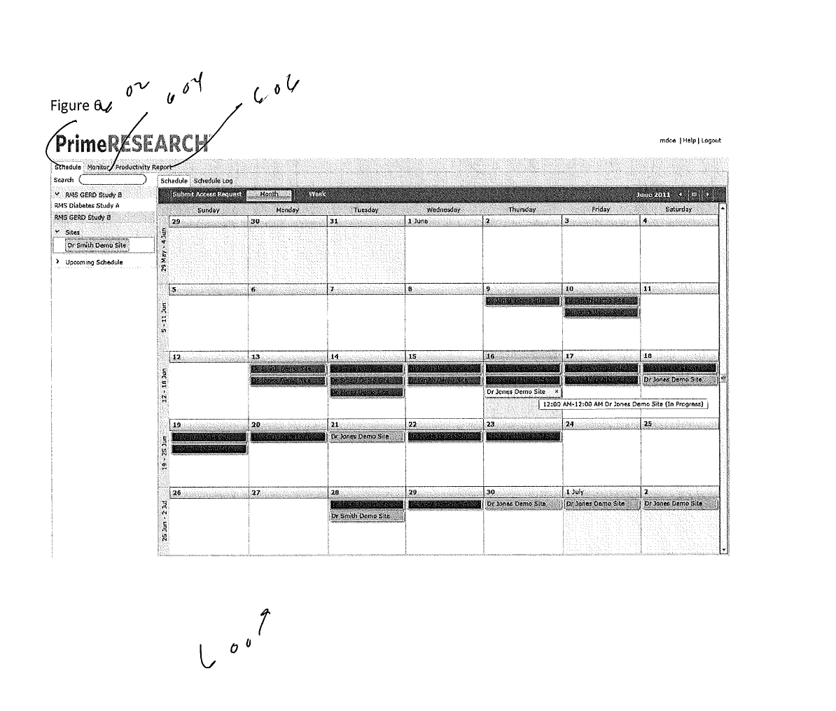

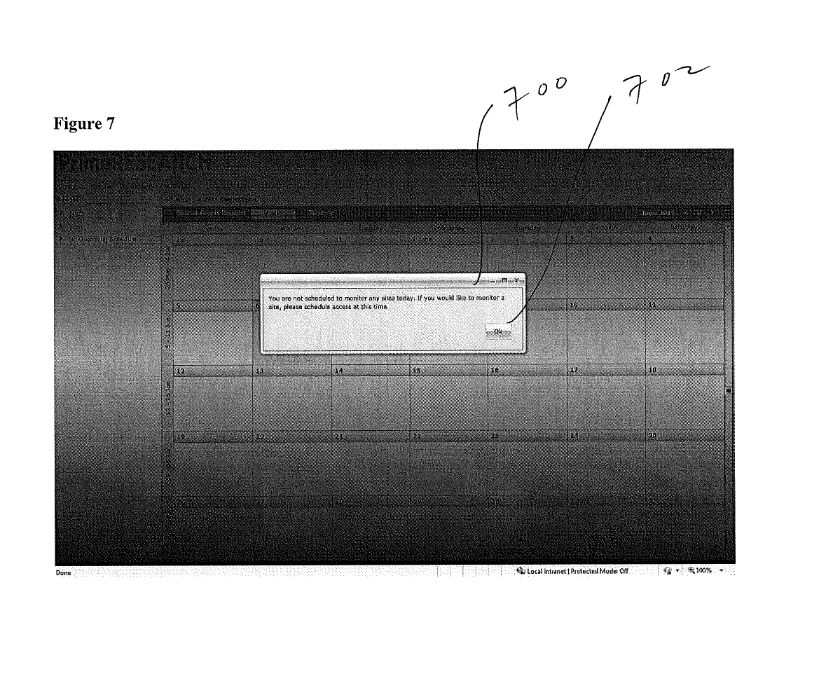

The monitor sees the screen 600 of FIG. 6. If a monitor has an access request scheduled for the day of access to the portal, the user will be able to view and navigate through the ‘Schedule’ tab 602, ‘Monitor’ tab 604, and ‘Productivity Report’ tab 606. If a monitor does not have an access request scheduled for the day of access to the portal, a system message shown in FIG. 7 as 700 will appear on the screen. After viewing it and clicking the ‘Ok’ button 702, the user will be navigated to ‘Schedule’ tab and will be able to schedule access for the day.

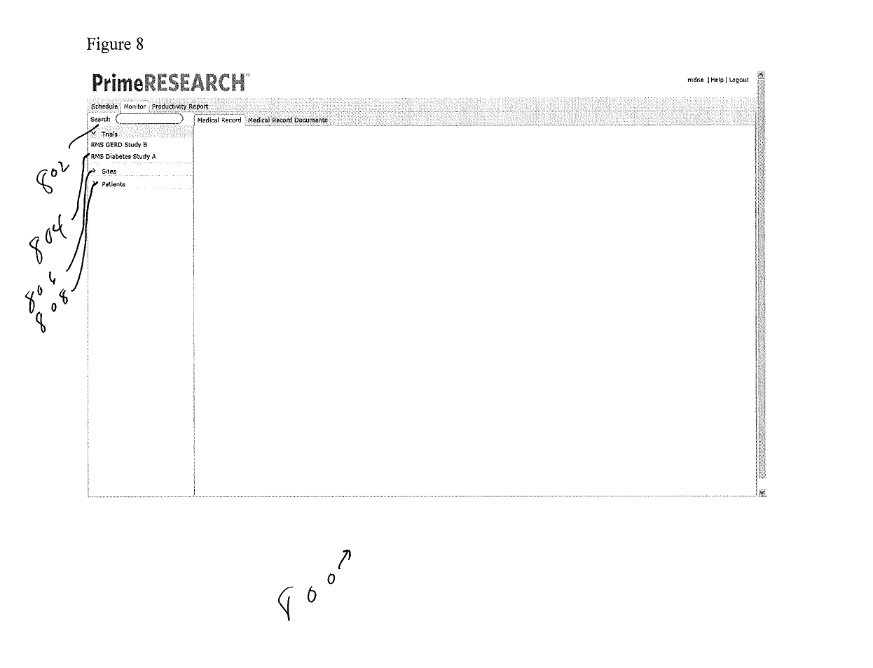

To navigate through and select from a list of trials to which the monitor is appointed, the user must click on the ‘Trials’ tab 802 in the screen 800 of FIG. 8. To navigate through and select from a list of sites participating in a particular trial, the user must click on the trial from a list 804 on the left side of the screen. To navigate through and select from a list of patients associated with a particular site, the user must click on the site from a list 806 on the left side of the screen. The user is able to utilize a search tool to navigate through trials, sites, and patients in order to locate needed subjects easily.

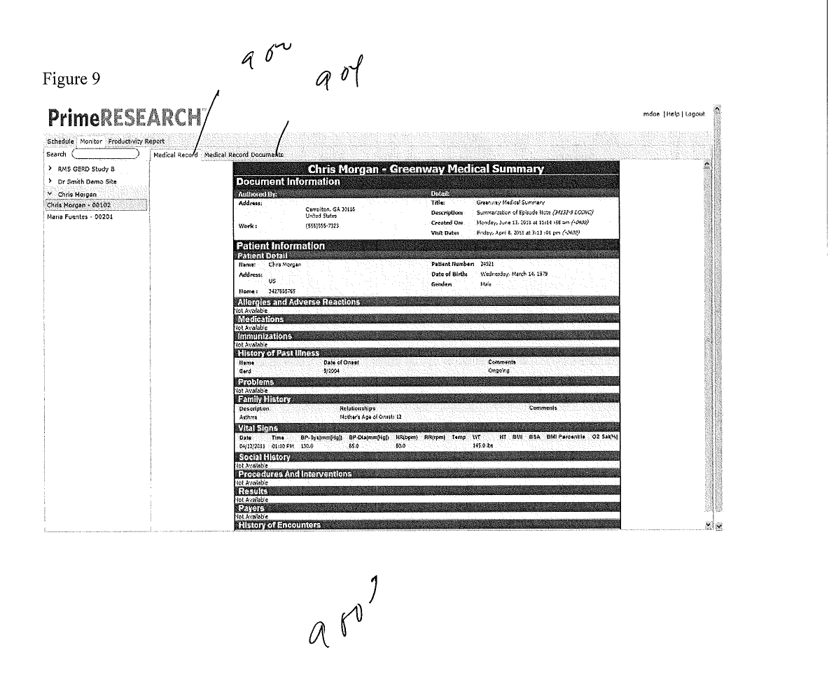

To access a patient's medical record and medical record documents, the user must select the patient from a list 808 on the left side of the screen. The patient's medical record, shown in FIG. 9 as 900, contains demographic and medical information pulled from PrimeSUITE. The medical record title must contain the patient's name.

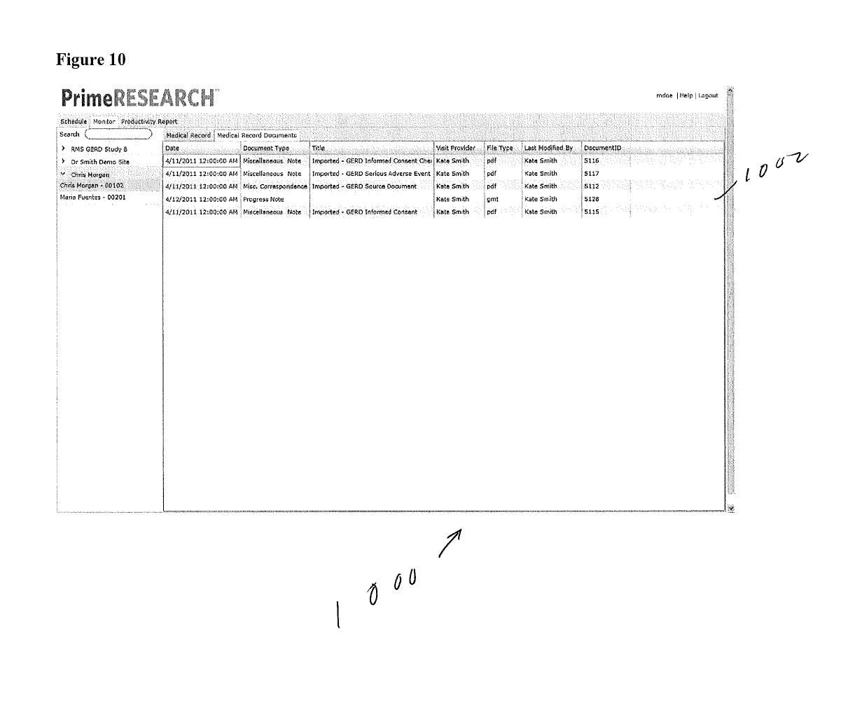

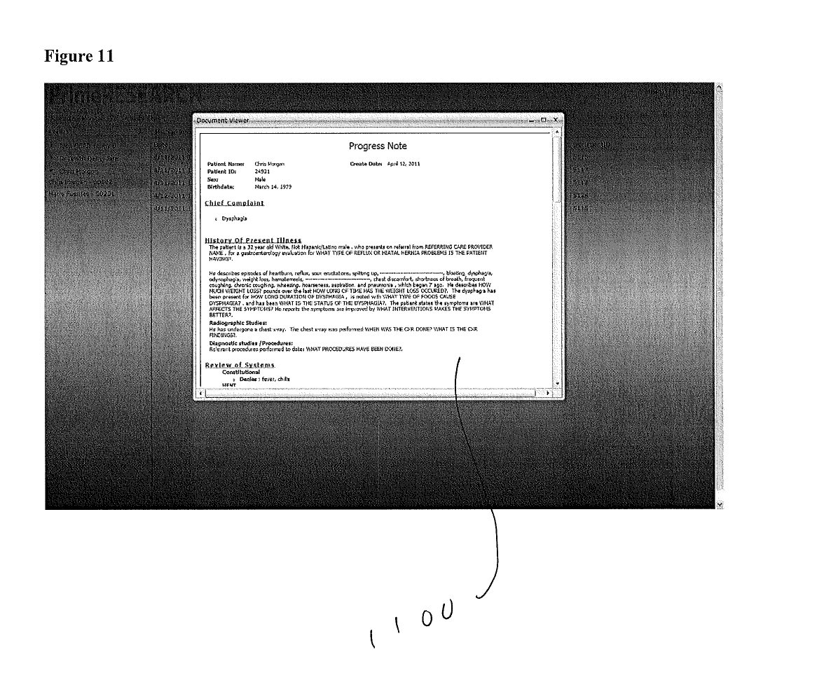

The user can switch between the “Medical Record” tab 209 and the “Medical Record Documents” tab 904. The ‘Medical Record Documents’ tab 904 contains a list of all saved and signed documents from a patient's medical chart, shown in FIG. 10 as 1000. To view and navigate through a particular document from the list, the user must click on the document 1002 which is then displayed in a new window, shown in FIG. 11 as 1100. The user is able to print a selected document should the trial call for printing. The user is able to search for a key word within an open medical document in order to locate that word easily.

To navigate through and select from a list of trials to which the monitor is appointed, the user must click on ‘Trials’ Tab. To navigate through and select from a list of sites participating in a particular trial, the user must click on the trial from a list on the left side of the screen. The user is able to utilize a search tool to navigate through trials and sites in order to locate needed subjects easily.

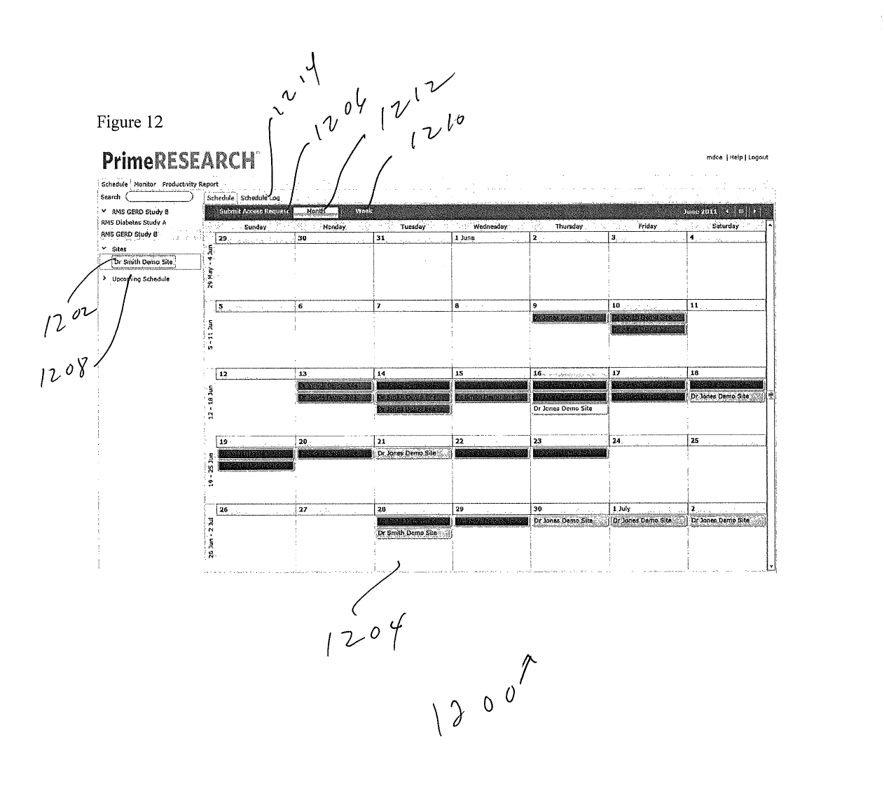

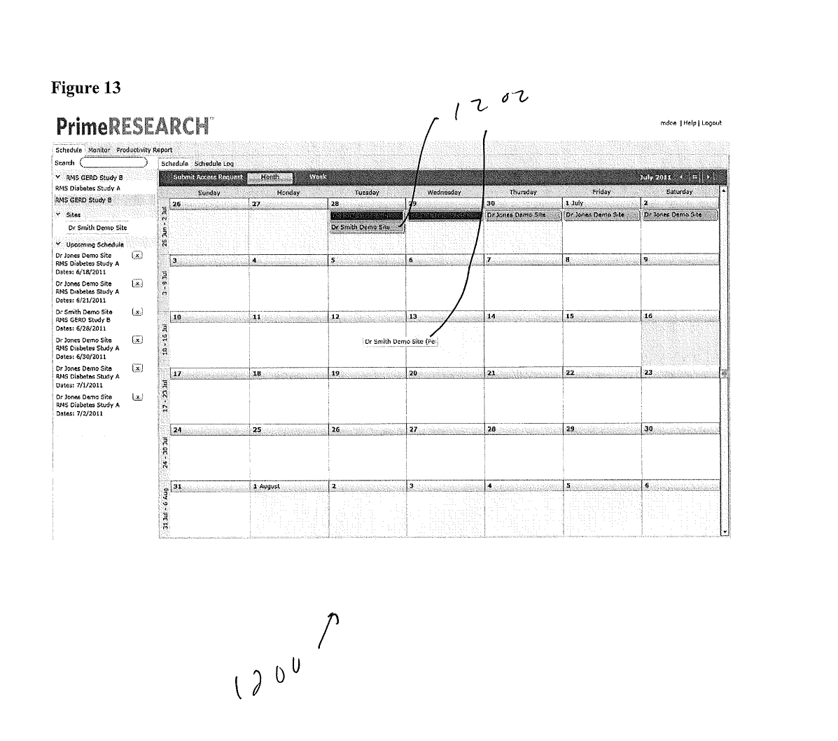

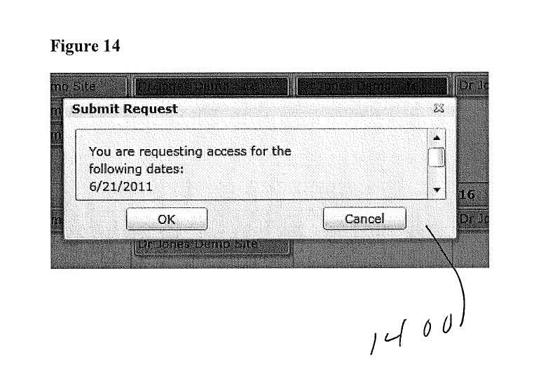

To schedule access for a specific date for a particular site, the user uses the screen 1200 of FIG. 12. The user must drag and drop the site button 1202 on the selected calendar cell 1204, as shown in FIG. 13, and click on the ‘Request Access’ button 1206. The system will generate a message shown in FIG. 14 as 1400, asking the user to review access dates and confirm the request. To view upcoming scheduled monitoring sessions, the user must click on the ‘Upcoming Schedule’ menu item 1208 on the left side of the screen.

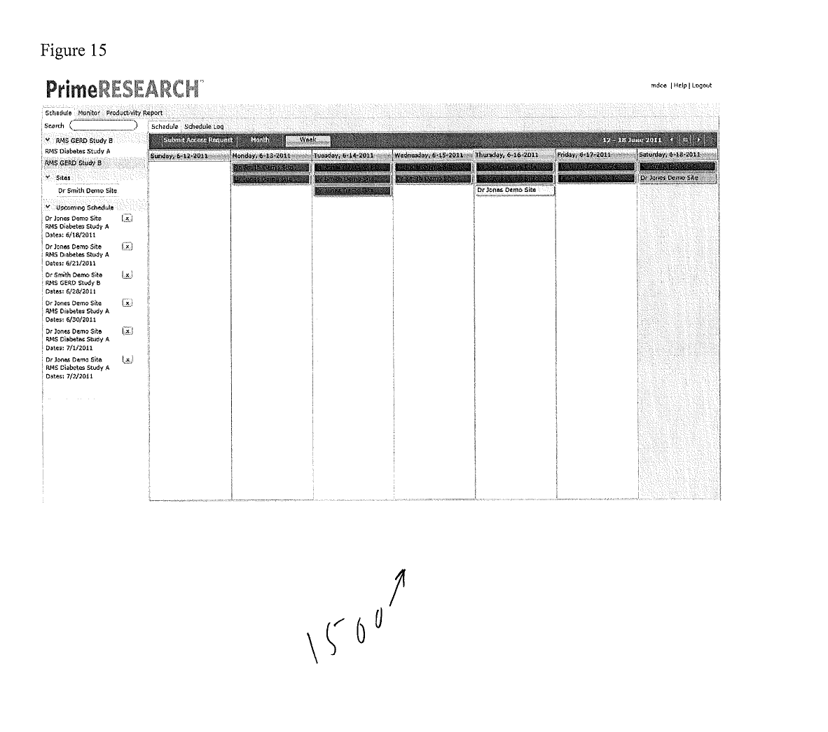

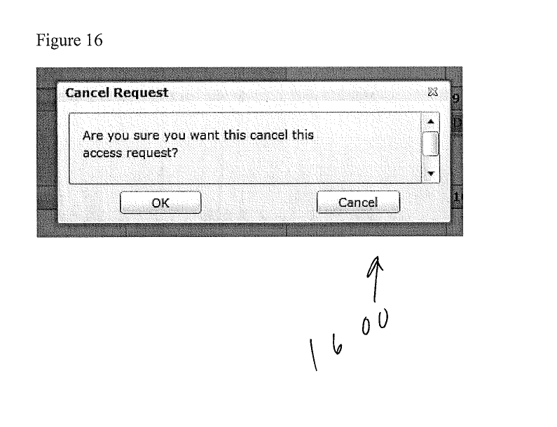

To view all access requests for a specific date, the user must click on the ‘Week’ button 1210 or the “Month” button 1212. The result is shown in FIG. 15 as 1500. To cancel an access request to a specific site, the user must click on “x” on the site button from a month view, week view, or upcoming schedule section. A dialog window, shown in FIG. 16 as 1600, appears on the screen asking the user to confirm cancelation of the access request.

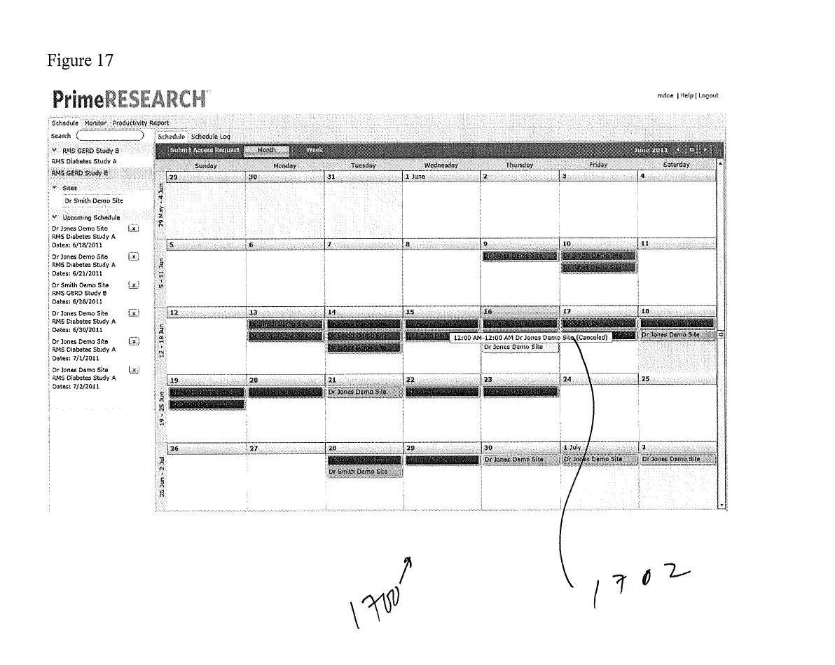

To view the status of an access request (Scheduled, Canceled, In Progress, Completed), the user must navigate to the site button on a month or week view, as shown in the screen 1700 of FIG. 17, in which a canceled access request 1702 is shown.

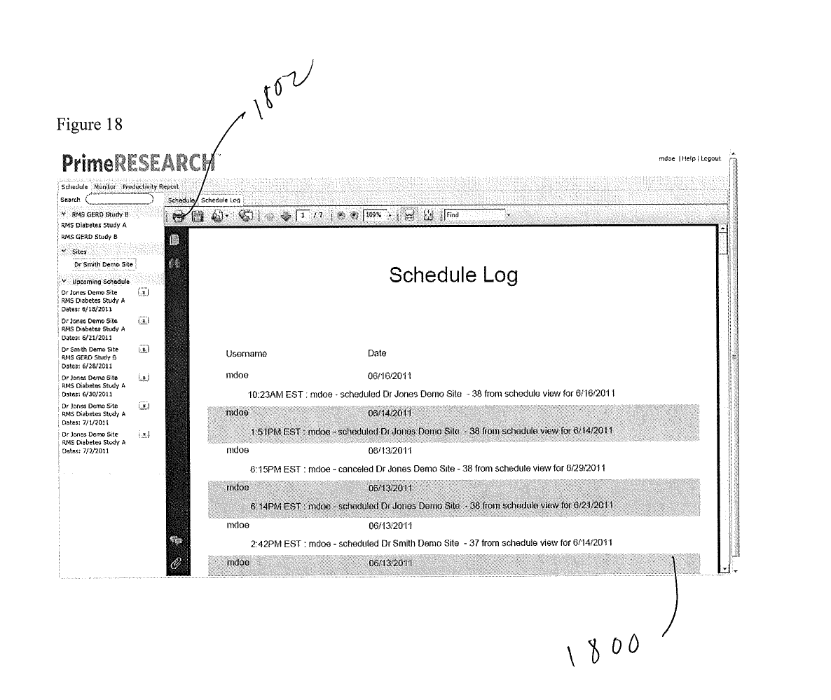

To view a log of all scheduling activities performed by the monitor (schedule or cancel), the user must click on the ‘Schedule Log’ tab 1214. The schedule log is shown in FIG. 18 as 1800. The user is able to print the Schedule Log by clicking on the ‘Print’ button 1802 on the left top corner of the report window.

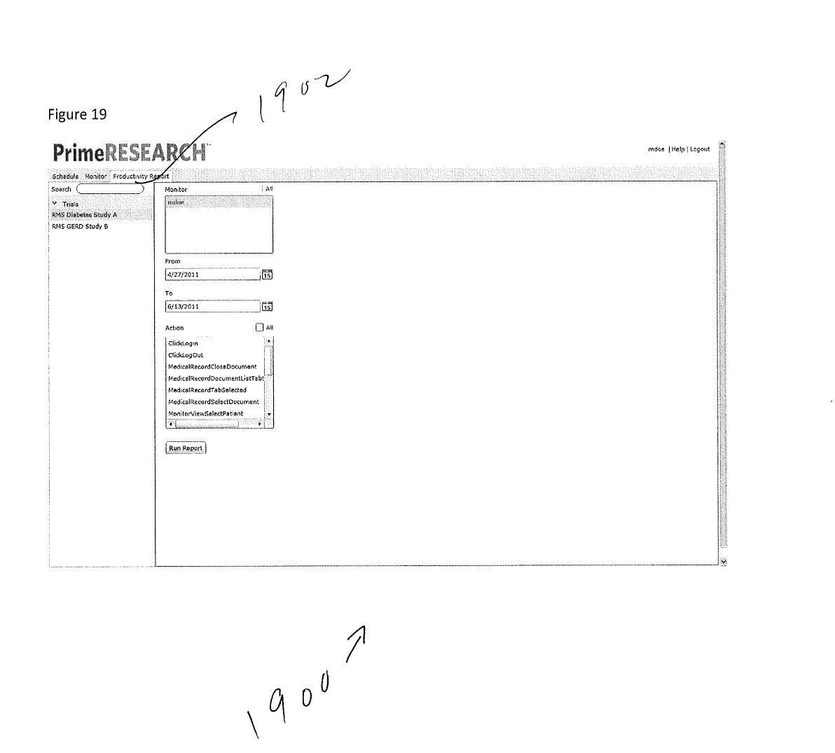

To navigate through and select from a list of trials to which the monitor is appointed, the user must click on a ‘Trial’ tab 1902 on the screen 1900 of FIG. 19. The user is able to utilize a search tool to navigate through trials in order to locate needed subjects easily.

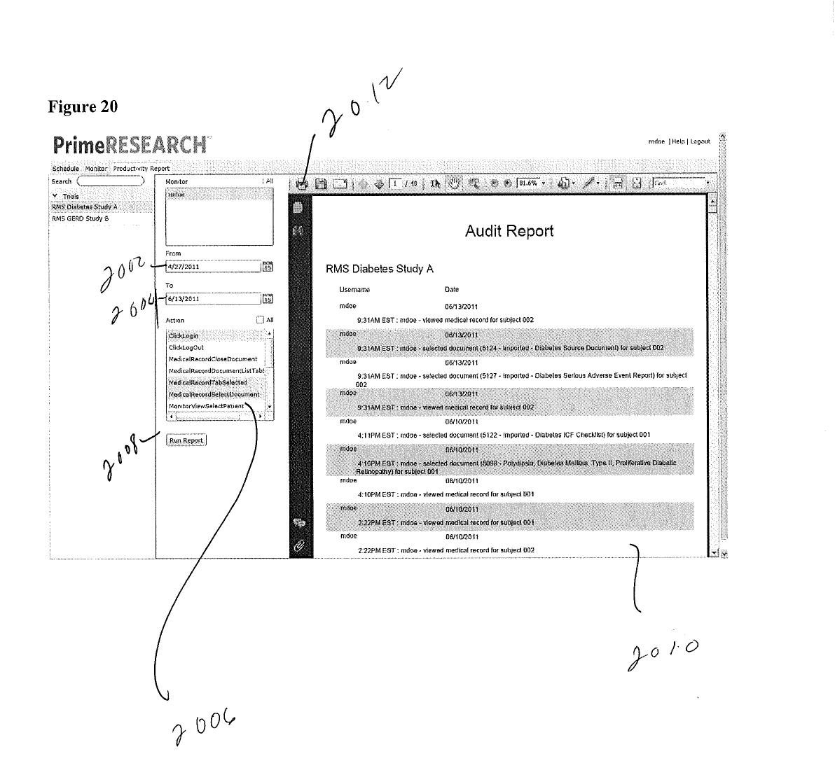

To view a Productivity Report, the user must select the “Productivity Report” tab 606, which brings up the screen 2000 of FIG. 20. The user set a desired date range using the date boxes 2002 and 2004, select all or specific actions form the list 2006, and click on the ‘Run Report’ button 2008 (for Monitor View a list of monitors contains only one row that reflects his/her name). The Productivity Report 2010 allows the user to view the date and time of a specific action performed within the portal. A list of actions includes: Click Login, Click Logout, Schedule View Select Trial, Schedule View select Site, Schedule View Schedule Dates, Schedule View Cancel Dates, Monitor View Select Trial, Monitor View Select Site, Monitor View Select Patient, Medical Record Tab Selected, Medical Record Documents List Tab Selected, Medical Record Select Document, Medical Record Close Document. The user is able to print the Productivity Report by clicking on the ‘Print’ button 2012 on the left top corner of the report window.

The sponsor/CRO view will now be disclosed.

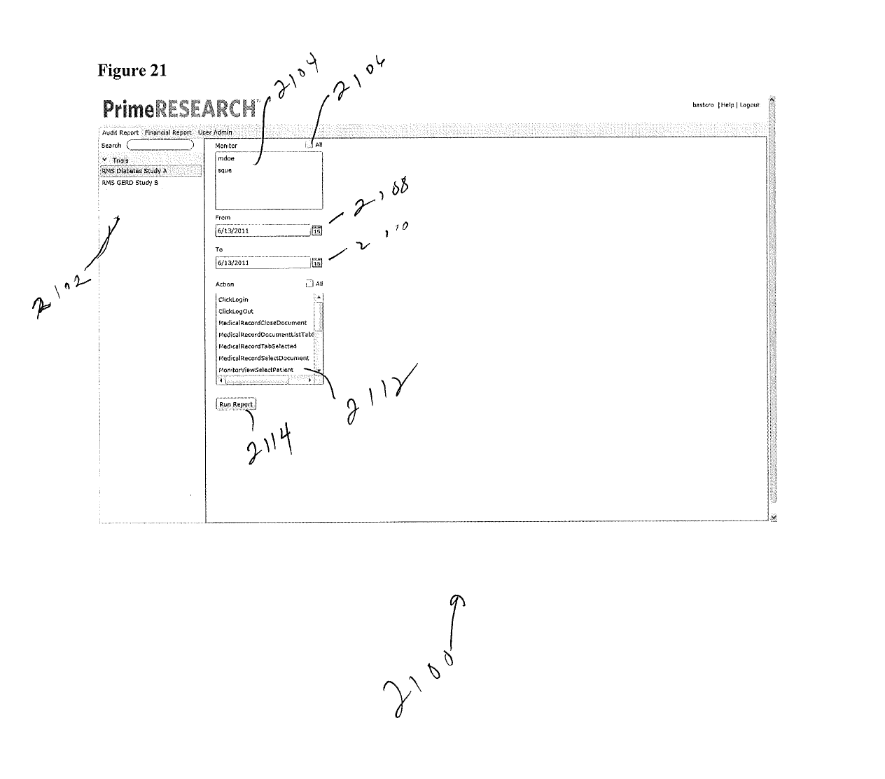

To navigate and select from a list of trials which a CRO oversees, the user must click on the ‘Trials’ Tab. In the screen 2100 of FIG. 21, to navigate and select from a list of monitors appointed to monitor a particular trial, the user must click on a selected trial from a list 2102 on the left side of the screen. The user is able to utilize a search tool to navigate through trials in order to locate needed subjects easily.

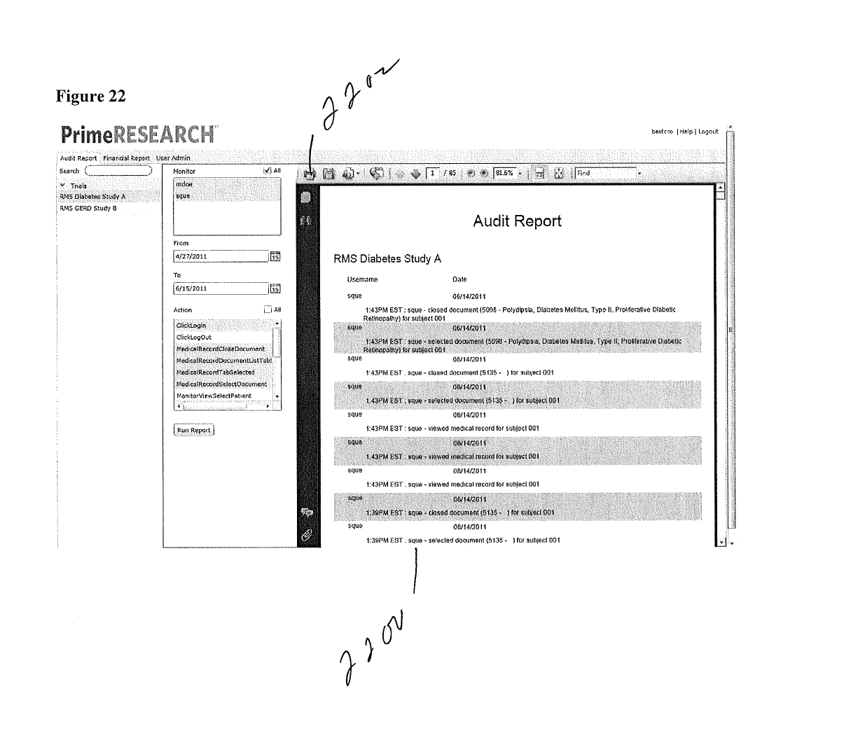

The user is able to select a monitor that he/she wants to run an Audit Report for from the list 2104 or click on the ‘All’ box 2106 and select all monitors appointed to the trial at once. To view an Audit Report, the user must set a desired date range in the date boxes 2108, 2110, select all or specific actions form the list 2112, and click on the ‘Run Report’ button 2114. The Audit Report allows the user to view the date and time of a specific action performed by selected monitors within the portal. A list of actions includes: Click Login, Click Logout, Schedule View Select Trial, Schedule View select Site, Schedule View Schedule Dates, Schedule View Cancel Dates, Monitor View Select Trial, Monitor View Select Site, Monitor View Select Patient, Medical Record Tab Selected, Medical Record Documents List Tab Selected, Medical Record Select Document, Medical Record Close Document. The user is able to print an Audit Report, shown in FIG. 22 as 2200, by clicking on the ‘Print’ button 2202 on the left top corner of the report window.

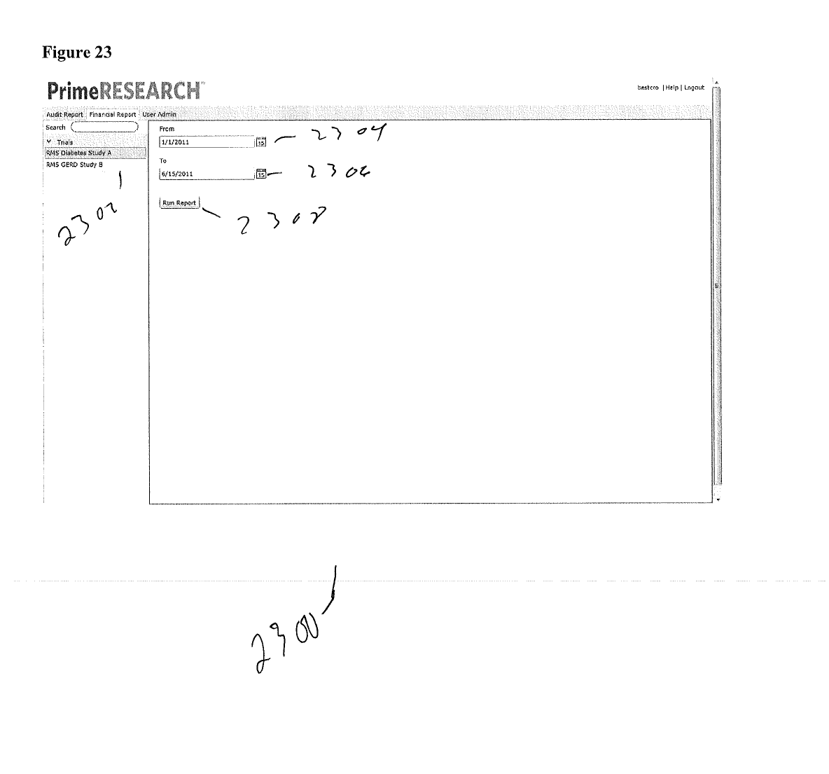

To select from a list of existing trials and run a financial report for an individual trial, the user must select the ‘Trials’ tab on the left side of the screen, which brings up the screen 2300 of FIG. 23. To select the specific trial, the user must click on the that trial in the list 2302, which will then allow the user to input data into ‘From’ and ‘To’ date boxes 2304, 2306 and click on the “Run Report” button 2308. The user is able to utilize a search tool to navigate through trials in order to locate needed subjects easily.

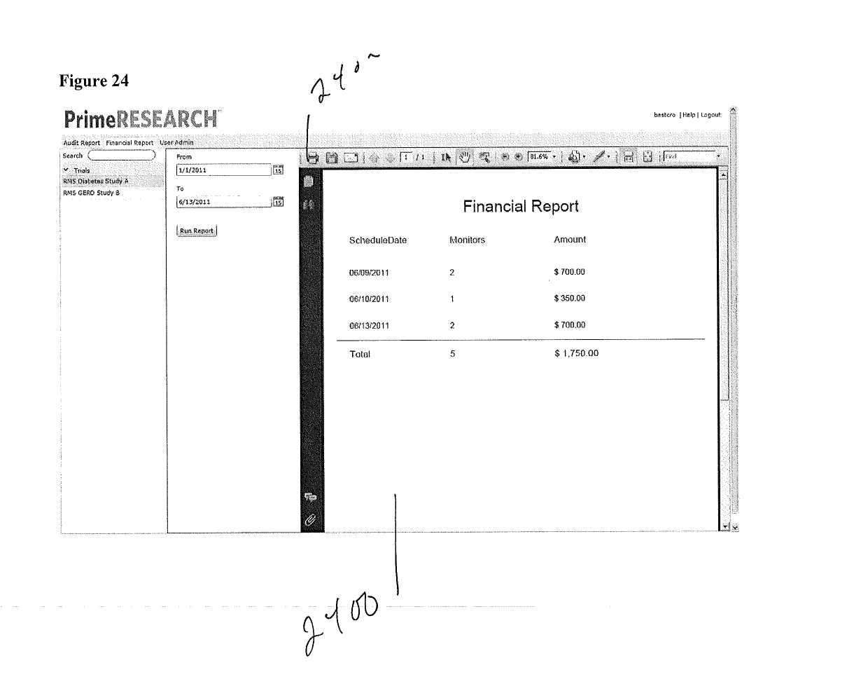

The user then will be able to view dates that an access had been scheduled for, how many monitors monitored on those dates, and the sum based on predetermined amount. In addition, the user will be able to review the total amount owed to the service for utilizing RMS system. The financial report is shown in FIG. 24 as 2400. The user is able to print a Financial Report by clicking on the ‘Print’ button 2402 on the left top corner of the report window.

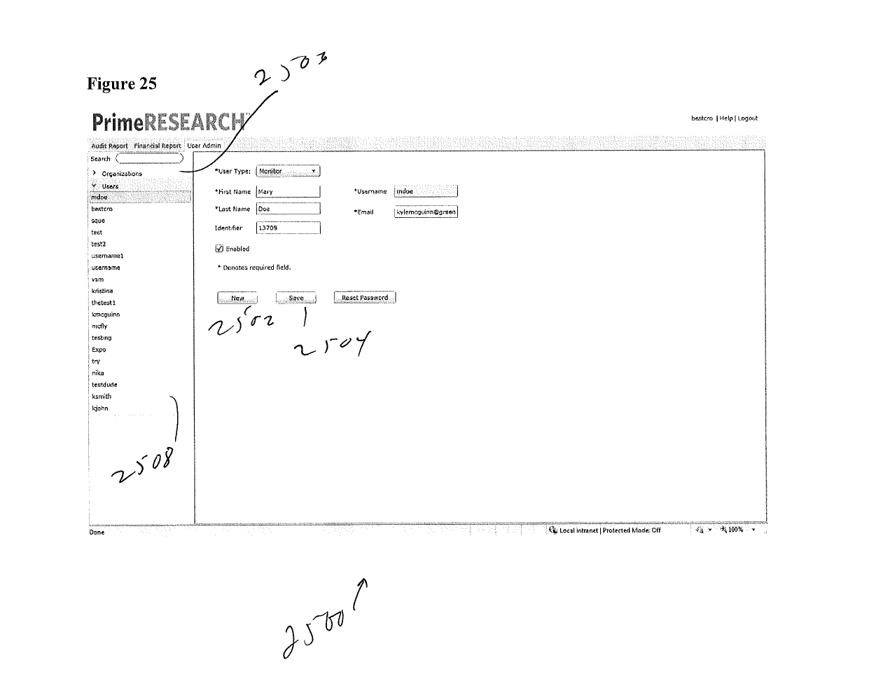

The ‘User Admin’ tab brings up the screen 2500 of FIG. 25, which allows the CRO/Sponsor to add other RMS users (other CROs and/or Monitors) to have access to the RMS portal so that they may view tabs and documents assigned to the user type created. The Admin is also able to select from a list of existing RMS users to view or edit their information. The user is able to utilize a search tool to navigate through the list of users in order to locate needed information easily.

To clear all fields on the screen, the Admin must click on the ‘New’ button 2502. Once all the fields are cleared, the Admin may enter required information for a new user. To create a new user, the Admin must enter information to all the required fields and click on the ‘Save’ button 2504. Once a new user is added, the created username will appear on the list on the left side of the screen, and the Admin will be able to view or edit the user's information.

To view a list of existing users, the Admin must select the Organization 2506 from a menu on the left side of the screen by clicking on it. To view or edit an existing user's information, the Admin must select a user from the list 2508 on the left side of the screen. The selected user's information will be populated in the fields, allowing the Admin to edit the user's data. After all needed changes are made; the Admin must click on the ‘Save’ button to push the new data into the database. To enable/disable an existing user, the Admin must check/uncheck the led check box and click on the ‘Save’ button. The system will generate a message notifying the Admin that the user's information has been updated.

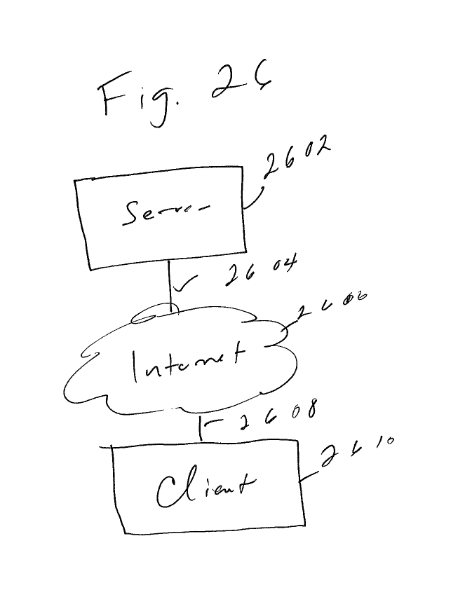

FIG. 26 shows an illustrative example of hardware on which the preferred or any other embodiment can be implemented. A server 2602 is programmed to implement the functionality of the present invention as well as that of the '998 application. The server communicates over a communication link 2604, the Internet 2606 or any other suitable communication network, and a communication link 2608 with a client device 2610. The client device 2610 is any device capable of running a Web browser and can be, e.g., a desktop, laptop, netbook, or tablet computer. The communication links can be wired or wireless (e.g., WiFi or cellular).

While a preferred embodiment has been set forth in detail, those skilled in the art who have reviewed the present disclosure will readily appreciate that other embodiments can be realized within the scope of the invention. For example, screen layouts are illustrative rather than limiting. Therefore, the scope of the invention should be construed as limited only by the appended claims.

What is claimed is:

1. A computer-implemented method for remotely monitoring studies and sites performing the studies, the method comprising:
(a) receiving, into a computer, a scheduling request from a user to monitor the studies and the sites;
(b) automatically remotely monitoring the studies and the sites from the computer in accordance with the scheduling request; and
(c) allowing the user to search, using the computer, for information regarding the studies and the sites.

2. The method of claim 1, further comprising providing a display on the computer to allow the user to see information on patients in the studies.

3. The method of claim 2, wherein the information on the patients in the studies comprises medical records and individual documents in the medical records.

4. The method of claim 1, wherein step (a) comprises:
providing a view on the computer of scheduling requests; and
allowing the user to add, change, and cancel the scheduling requests.

5. The method of claim 1, further comprising:
automatically generating a schedule log in response to a command by the user; and
displaying the schedule log on the computer.

6. The method of claim 1, wherein step (c) comprises:
automatically generating an audit report in response to a command by the user; and
displaying the audit report on the computer.

7. The method of claim 1, wherein step (c) comprises:
automatically generating a financial report in response to a command by the user; and
displaying the financial report to the user.

8. A computer-implemented system for remotely monitoring studies and sites performing the studies, the system comprising:
a communication component for communicating with a user; and
a processor in communication with the communication component, the processor being configured for:
(a) receiving a scheduling request from a user to monitor the studies and the sites;
(b) automatically remotely monitoring the studies and the sites in accordance with the scheduling request; and
(c) allowing the user to search for information regarding the studies and the sites.

9. The system of claim 9, wherein the processor is further configured for providing a display to allow the user to see information on patients in the studies.

10. The system of claim 9, wherein the information on the patients in the studies comprises medical records and individual documents in the medical records.

11. The system of claim 8, wherein the processor is configured to perform step (a) by:
providing a view on the computer of scheduling requests; and
allowing the user to add, change, and cancel the scheduling requests.

12. The system of claim 8, wherein the processor is further configured for:
automatically generating a schedule log in response to a command by the user; and
displaying the schedule log on the computer.

13. The system of claim 8, wherein the processor is configured to perform step (c) bt:
automatically generating an audit report in response to a command by the user; and
displaying the audit report on the computer.

14. The system of claim 8, wherein the processor is configured to perform step (c) by:
automatically generating a financial report in response to a command by the user; and
displaying the financial report to the user.
